(19) United States
(12) Patent Application Publication
(10) Pub. No.: US 2001/0034304 A1
(43) Pub. Date: Oct. 25, 2001

(54) Manufacture and use of an deposition aid

(76) Inventors: Greg Volgas, Bartlett, TN (US); Johnnie R. Roberts, Memphis, TN (US); Robert Mack, Bartlett, TN (US)

Correspondence Address: Connolly, Bove, Lodge & Hutz, LLP, 1220 Market Street, P.O. Box 2207, Wilmington, DE, 19899-2207, US

(21) Appl. No.: 09/765,765

(22) Filed: Jan. 19, 2001

Related U.S. Application Data
(63) Continuation-in-part of application No. 09/734,637, filed on Dec. 12, 2000.
(60) Provisional application No. 60/177,420, filed on Jan. 21, 2000.

(51) Int. Cl. A01N 57/18; A01N 25/10

(52) U.S. Cl. 504/206; 71/27; 504/361

(57) ABSTRACT

A homogenous composition which contains

at least one pesticide and

at least one deposition or drift agent.

This application claims benefit to provisional Serial No. 60/177,420 Filed Jan. 21, 2000, and Ser. No. 09/734,637 filed Dec. 12, 2000 which are incorporated by reference in its entirety for all useful purposes.

### BACKGROUND OF THE INVENTION

Polyacrylamide or polyvinyl polymers and natural gums, like guar gum, have been used for several years as deposition or drift reducing agents. U.S. Pat. No. 5,964,917 has shown the benefits of nitrogenous fertilizers, non-derivatized guar gum, cationic guar gum, and non-cationic guar gum, and mixtures, thereof and a silicone defoamer. One problem of this patented formulation is that it must include a silicone defoamer. Another problem with this formulation is the reliance on nitrogenous fertilizers. This formulation is also restricted unnecessarily to a dry form. The amount of nitrogenous fertilizer required is unnecessarily high with relation to the amount of guar. Finally, this prior art is restricted to using non-derivatized guar gum, cationic guar gum, and non-cationic guar gum, and mixtures, thereof It would be beneficial to use other less expensive drift control agents or deposition agents.

A product currently on the market contains 1% of a polyacrylamide polymer and roughly 10-20% of ammonia salts (sulfate or carboxylic acid) and 1-2% a silicone defoamer. This product is a liquid and does not perform adequately in some instances due to the low level of polyacrylamide polymer used.

Other liquid products currently available contain 30-35% ammonia sulfate, 1-2% polyacrylamide and a silicone defoamer at 1-3%.

Other dry products currently being marketed have some of the same limitations of the patented product described above. Specifically, these products contain about 1-5% of polyacrylamide or polyvinyl polymers, 90-96% of ammonia salts (Ammonia carboxylate, sulfate and polyacrylate) and 1-2% of a silicone defoamer.

Another liquid product contains 1-2% modified guar gum, 30-35% ammonia sulfate, and no defoamer. A similar product contained the same amounts as this one, but also included 5-10% of diethylene glycol as an anti-freeze.

Another liquid product contains 20-30% ammonia sulfate and water, and in another layer of the liquid, contains aromatic acids and aliphatic petroleum distillates.

Another dry product on the market contains 5-10% of a blend of polyacrylamide polymers and xantham gum, and 90-95% ammonia sulfate and 1-5% silicone defoamer.

In U.S. Pat. Nos. 5,529,975 and 5,525,575, Chamberlain describes the use of oils and water to produce stable dispersions of acrylamide polymers for deposition and drift control.

### SUMMARY OF THE INVENTION

The present invention is a homogenous agricultural composition containing at least one fertilizer or oil and at least one deposition agent. Our new discovery is that lower rates of nitrogenous fertilizers and correspondingly higher rates of non-derivatized guar gum, cationic guar gum, and non-cationic guar gum, and mixtures, thereof can also provide benefits to agricultural applicators. Furthermore, we have discovered alternatives to nitrogenous fertilizers that when combined with non-derivatized guar gum, cationic guar gum, and non-cationic guar gum, and mixtures, thereof, provide beneficial spray characteristics. Also, we have discovered that other deposition agents can be added to fertilizers to enhance their efficiency. The use of defoamers is helpful, but not required. We have also discovered a way to deliver the benefits of natural gums in liquid oil-based compositions. In many cases, the oil provides the same benefits as the fertilizer; i.e. increased pesticide efficacy and easier use of the deposition and drift control agent.

The present invention is also a homogeneous agricultural composition containing at least 1 polymeric deposition agent and a pesticidal agricultural chemical. Of particularly utility, the present invention allows the introduction of polymeric deposition agent functions into herbicide formulations. In these formulations, the addition of a fertilizer is not necessary, but possible.

The nitrogenous fertilizers of the present invention include, but are not limited to:

Ammonia salts; including but not limited to:

Ammonium sulfate,

Ammonium bisulfate,

Ammonium salts of carboxylic acids,

Ammonium chloride,

Ammonium carbonate,

Ammonium phosphate,

Ammonium nitrate,

Ammonium thiosulfate and

Ammonium hydroxide,

Urea-Ammonia nitrate solutions,

Urea;

Urea phosphate;

Potassium nitrate and

Urea-formaldehyde polymers.

Others included are described from the AAPFCO guide, 1998, (Association of American Plant Food Control Officials, Official Publication Number 51) which is incorporated by reference in it's entirety for all useful purposes.

The non-nitrogenous fertilizers of the present invention include, but are not limited to:

Potash sources, including but not limited to

Potassium phosphate (mono- or di-),

Potassium carbonate,

Potassium chloride,

Potassium sulfate,

Potassium salts of carboxylic acids,

Potassium phosphite,

Others included are described AAPFCO guide, 1998 again, which is incorporated by reference in it's entirety for all useful purposes.

Phosphate sources, including but not limited to

Phosphoric acid,

Phosphorous acid,

Others included which are incorporated by reference in its entirety from the AAPFCO guide, 1998.

Micronutrients and secondary nutrients, including, but not limited to:

Compounds containing more than 1% by dry weight of the following micronutrients and secondary nutrients:

Zinc,

Manganese,

Magnesium,

Iron,

Calcium,

Sulfur,

Boron,

Cobalt,

Chlorine,

Copper,

Molybdenum,

Sodium,

Others included which are incorporated by reference in its entirety from the AAPFCO guide, 1998.

The deposition agents of the present invention include, but are not limited to:

Polymeric deposition agents, including but not limited to

polyarcylamides or their copolymers or derivatives,

polymers and copolymers of acrylic acid and methacrylic acid or their salts,

polymethacrylamides or their copolymers or derivatives,

polyacrylonitriles, their hydrolysis products, copolymers, or derivatives

polyvinyl polymers, copolymers, or derivatives,

Natural gums, including but not limited to

Non-derivatized guar gum, cationic guar gum, and non-cationic guar gum, and mixtures, thereof,

Xantham gum,

Gum acacia,

Gum Tragacanth,

Gum Arabic.

The Oil or oil substitutes include but are not limited to:

Alkylated fatty acid esters, include but are not limited to:

Methylated fatty acids, including but not limited to:

Methylated C6-19 fatty acids,

Methylated Tall oil fatty acids,

Methylated Oleic acid,

Methylated Linoleic acid,

Methylated Linolenic acid,

Methylated Stearic acid,

Methylated Palmitic acid,

And blends thereof;

Ethylated fatty acids, include but are not limited to:

Ethylated C6-19 fatty acids,

Ethylated Tall oil fatty acids,

Ethylated Oleic acid,

Ethylated Linoleic acid,

Ethylated Linolenic acid,

Ethylated Stearic acid,

Ethylated Palmitic acid,

And blends thereof,

Butylated fatty acids, include but are not limited to:

Butylated C6-19 fatty acids,

Butylated Tall oil fatty acids,

Butylated Oleic acid,

Butylated Linoleic acid

Butylated Linolenic acid,

Butylated Stearic acid,

Butylated Palmitic acid,

And blends thereof;

Alkylated natural oils, include but are not limited to:

Alkylated soybean oil, including, but limited to:

Methylated soybean oil,

Ethylated soybean oil,

Butylated soybean oil,

And blends thereof;

Alkylated canola oil, include but are not limited to:

Methylated canola oil,

Ethylated canola oil,

Butylated canola oil,

And blends thereof;

Alkylated coconut oil, include but are not limited to:

Methylated coconut oil,

Ethylated coconut oil,

Butylated coconut oil,

And blends thereof.

Alkylated sunflower oil, include but are not limited to:

Methylated sunflower oil,

Ethylated sunflower oil,

Butylated sunflower oil,

And blend thereof;

Hydrocarbon oils include but are not limited to:

Mineral Oils, including but are not limited to:

Paraffinic mineral oils,

Naphthenic mineral oils,

Aromatic mineral oils,

And blends thereof;

Vegetable oils, include but are not limited to:

Soybean oil,

Canola oil,

Cottonseed oil,

And blends thereof;

Fatty acids, include but are not limited to:

C6-19 fatty acids,

Tall oil fatty acids,

Oleic acid,

Linoleic acid,

Linolenic acid,

Stearic acid,

Palmitic acid,

And blends thereof;

Polybutenes

Epoxified seed oils include but are not limited to:

Epoxified soybean oil and

Other oils or oil substitutes

The oil can contain at least one of the above oils or its equivalent. The oil can also be a blend of at least two oils. When an oil is used, a surfactant or emulsifier must also be used if the composition is intended for aqueous based sprays.

Oil based compositions of this invention may optionally contain thickening agents to improve formulation stability. These thickening agents include but are not limited to:

Silicon containing thickeners, such as:

Precipitated silicas or

Precipitated silicates.

Oil based compositions of this invention may contain water, but this is generally not required until the end user adds the concentrate to water for final use.

The defoamers of the present invention include, but are not limited to:

Silicone based defoamers which are described in U.S. Pat. No. 5,964,917, which is incorporated by reference in its entirety herein for all useful purposes. This invention can be practiced with or without the use of silicone defoamers.

The present invention allows for a wide range of compositions under the following limitations:

The composition contains

1-99% by weight of at least one water soluble or water insoluble fertilizer.

preferably less than 87.5% of a nitrogenous fertilizer or 10-99% of a non-nitrogenous fertilizer

more preferably 15-85% of a nitrogenous fertilizer or 15-95% of a non-nitrogenous fertilizer

most preferably 35-75% of a nitrogenous fertilizer or 25-95% of a non-nitrogenous fertilizer.

0.5-99% by weight of a deposition agent

preferably 0.5-50% of a deposition agent

most preferably 12.5-40% of a deposition.

where said deposition agent is preferably non-derivatized guar gum, cationic guar gum, or non-cationic guar gum, or mixtures, thereof, or polyacrylamide or polyvinyl polymers. If the fertilizer contains nitrogenous fertilizer, non-derivatized guar gum, cationic guar gum, and non-cationic guar gum, and mixtures, thereof, gum, and a silicone defoamer, the amount of nitrogenous fertilizer must be less than 87.5% of the total product weight, preferably less than 85%. The formulation can be liquid or dry, most preferably dry. If dry, the powdered ingredients are either dry-blended or ground to a fine powder that will pass through a 30 mesh screen. (This corresponds to a particle that is less than 0.59 millimeters in diameter).

The composition optionally contains one or several of the following

Additional agricultural adjuvants,

Defoaming agents,

Pesticides, including herbicides, insecticides and fungicides and as further defined by the Code of Federal Regulations.

Buffering agents,

Surfactants and

Sequestrants.

If a defoaming agent is used, it is preferably a silicone defoamer used at greater than 12.50%. Most preferably, this silicone defoamer would be used at 12.5-20.%. If a non-silicone defoamer is used, it is preferably used at 0.1-10.0%. Most preferably, a non-silicone defoamer is used at 1.0-5.0%. It is also possible that mixtures of these defoamers can be used.

The following patents and reference, which include several ingredients that can be used according to this invention, are incorporated by reference in its entirety for all useful purposes:

U.S. Pat. No. 5,741,502 Homogeneous, essentially nonaqueous adjuvant compositions with buffering capability

U.S. Pat. No. 5,725,630 Dry granular fertilizer blend and a method of fertilizing plants

U.S. Pat. No. 5,580,567 Homogeneous, essentially nonaqueous adjuvant compositions with buffering capability

U.S. Pat. No. 5,393,791 Homogeneous, essentially nonaqueous adjuvant compositions with buffering capability

U.S. Pat. No. 5,234,919 Water soluble, highly active dimethoate formulations in an alcohol/ester solvent system

U.S. Pat. No. 5,178,795 Homogeneous, essentially nonaqueous adjuvant compositions with buffering capability

U.S. Pat. No. 5,906,961 Alkanolamide spreader-sticker surfactant combination

U.S. Pat. No. 5,877,112 Agricultural formulation

AAPFCO guide, 1998, (Association of American Plant Food Control Officials, Official Publication Number 51)

Pesticides can also be used in this invention. Pesticides, include but are not limited to:

Water insoluble pesticides include but are not limited to:

Water insoluble Herbicides,

Water insoluble Insecticides,

Water insoluble Fungicides,

Water insoluble Bactericides and

Water insoluble rodenticides.

Water soluble pesticides, include but are not limited to:

Water soluble Herbicides,

Water soluble Insecticides,

Water soluble Fungicides,

Water soluble Bactericides and

Water soluble rodenticides.

Some examples of the composition include

EXAMPLE 1

| Ingredients: | % by weight |
|---|---|
| Ammonia sulfate | 50.0% |
| Agrho DR-2000 | 37.5% |
| Silicone defoamers | 1.0% |
| Buffering agents | 11.5% |

The composition in example 1 was made by dry blending the materials. No change is anticipated in the utility of this composition based on manufacturing temperature, pressure, or grinding.

The buffering agent in Example 1 is citric acid and the Agrho DR-2000 is a modified guar gum. Agrho DR-2000 functions as a drift control agent and deposition agent. This formulation also contains a silicone based defoamer. This formulation is used in an aqueous based spray at the rate of 0.5-2.0 pounds per 100 gallons of total spray volume.

Because of the lower use rates of this product as compared with formulations produced under U.S. Pat. No. 5,964,917, formulas made like example 1 are easier to use. The time required for dissolution of this new formulation is about ½ of the time required for that of the prior art. The buffering agents also enhance the pesticide activity of many herbicides and insecticides. The pH of the prior art formulations was about neutral, while Example 1 gives a pH of 3.0 at 0.5% in water.

EXAMPLE 2

| Ingredients: | % by weight |
|---|---|
| Mono-Potassium phosphate | 93.0% |
| Agrho DR-2000 | 6.0% |
| Silicone defoamer | 1.0% |

In example 2, the ammonia salts have been completely replaced by mono-potassium phosphate (MKP). MKP has shown not only buffering ability, but the ability to tie up metal cations as well or better than ammonia sulfate. This is an important point for many herbicides, such as glyphosate, which can be tied up by cations in spray water. The use rate of Example 2 is 6-20 pounds per 100 gallons of total spray solution and is intended for aqueous based sprays.

EXAMPLE 3

| Ingredients: | % by weight |
|---|---|
| Ammonia sulfate | 93.0% |
| Gum acacia | 6.0% |
| Silicone defoamer | 1.0% |

In example 3, the guar gum used in prior art formulations has been replaced by gum acacia. This alternate gum is often less expensive than guar gum and yet behaves in essentially the same way. Here is no buffering agent added or any real buffering ability afforded by the use of ammonia sulfate. The use rate of Example 3 is 6-20 pounds per 100 gallons of total spray solution and is intended for aqueous based sprays.

EXAMPLE 4

| Ingredients: | % by weight |
|---|---|
| Water | 50.0% |
| Ammonia sulfate | 49.0% |
| Agrho DR-2000 | 1.0% |

In example 4, the formulation is put into liquid form. This greatly improves the ease of use of the composition.

EXAMPLE 5

| Ingredients: | % by weight |
|---|---|
| Water | 50.0% |
| Mono-potassium phosphate | 48.0% |
| Agrho DR-2000 | 1.0% |
| Silicone defoamer | 1.0% |

In example 5, the components of example 2 are dissolved into water. Again, this greatly improves the ease of use of the formulation.

EXAMPLE 6

| Ingredients: | % by weight |
|---|---|
| 2,4-D Amine Tech | 65.0% |
| Polyacrylamide polymers | 2.0% |
| Monopotassium phosphate | 10.0% |
| Water | 23.0% |

EXAMPLE 7

| Ingredients | % by weight |
|---|---|
| Isopropylamine salt of glyphosate | 65.0% |
| Polyacrylamide polymers | 3.0% |
| Monopotassium phosphate | 15.0% |
| Water | 17.0% |

In examples 6 and 7, the polyacrylamide polymers act as a drift reduction agent and deposition agent. 2,4-D amine and glyphosate are water-soluble herbicides.

EXAMPLE 8

| Ingredients | % by weight |
|---|---|
| Mineral oil | 86.0% |
| Aghro DR-2000 | 5.0% |
| Emulsifier | 5.0% |
| Aerosil R-972 | 4.0% |

In example 8, the formulation is also in liquid form. In this case, oil has replaced the fertilizers in prior formulations. Oil based products are well known to enhance the effectiveness of many pesticides. Aerosil R-972 is a silicon-based thickening agent specifically designed for use in hydrophobic formulations. The emulsifier is a surfactant and helps the formulation readily disperse in aqueous based spray solutions. The use rate of Example 8 is 0.25-2.0% volume to volume. It is designed to be used in aqueous based sprays.

EXAMPLE 9

| Ingredients | % by weight |
|---|---|
| Isopropylamine salt of glyphosate | 65.0% |
| Polytex A363 | 4.0% |
| Water | 31.0% |

In example 9, the formulation is in liquid form. In this case, the Polytex A363 is a polymeric deposition agent. This formulation, as the others, can then be used by pesticide applicators by dilution in a spray carrier, usually water.

EXAMPLE 10

| Ingredients | % by weight |
|---|---|
| Isopropylamine salt of glyphosate | 65.0% |
| Polytex A363 | 4.0% |
| Silicone defoamer | 1.0% |
| Water | 30.0% |

In example 9, the formulation is in liquid form. In this case, the Polytex A363 is a polyacrylamide type polymeric deposition agent. This formulation, as the others, can then be used by pesticide applicators by dilution in a spray carrier, usually water.

Example 11

| Ingredients | % by weight |
|---|---|
| Glyphosate ammonium salt | 95.0% |
| Guar gum | 5.0% |

In example 11, the formulation is a powder. The glyphosate ammonium salt is a dry herbicide, and the guar gum is a polymeric deposition agent.

All the references discussed in this application are incorporated by reference in their entirety for all useful purposes.

While there is shown and described certain specific structures embodying the invention, it will be manifest to those skilled in the art that various modifications and rearrangements of the parts may be made without departing form the spirit and scope of the underlying inventive concept and that the same is not limited to the particular forms herein shown and described.

We claim:

1. A homogenous composition comprising
(a) at least one pesticide and
(b) at least one deposition or drift agent.

2. The composition as claimed in claim 1, wherein said pesticide is a herbicide.

3. The composition as claimed in claim 1, wherein said deposition or drift agent is a non-derivatized guar gum, cationic guar gum, non-cationic guar gum, or a polymeric deposition agent, or mixtures thereof.

4. The composition as claimed in claim 3, wherein the polymeric deposition agent is a polyacrylamide polymer.

5. The composition as claimed in claim 2, wherein the herbicide is glyphosate or salt thereof.

6. The composition as claimed in claim 1, which further comprises a silicone defoaming agent
